(19) United States
(12) Patent Application Publication
(10) Pub. No.: US 2017/0136800 A1
(43) Pub. Date: May 18, 2017

(54) ANGLED PRINTED BOUND BOOK

(71) Applicant: Sarfaraz K. Niazi, Deerfield, IL (US)

(72) Inventor: Sarfaraz K. Niazi, Deerfield, IL (US)

(21) Appl. No.: 15/383,971

(22) Filed: Dec. 19, 2016

Related U.S. Application Data
(63) Continuation-in-part of application No. 15/188,636, filed on Jun. 21, 2016.
Application No. 15/188,636 is a continuation-in-part of application No. 14/308,462, filed on Jun. 18, 2014, now abandoned.

(51) Int. Cl. B42D 1/00; H04N 1/387

(52) U.S. Cl. CPC B42D 1/009; H04N 1/3877

(57) ABSTRACT

A method for improving readability and comprehension of printed text or image by printing at an angle as a mirror image on the left and right page of a bound book is disclosed.

### CROSS REFERENCE TO RELATED APPLICATION

This application is a continuation-in-part of U.S. patent application Ser. No. 15/188,636, entitled “Visual Axis Optimization for Enhanced Readability and Comprehension” filed on Oct. 13, 2016; which is a continuation in part of U.S. patent application Ser. No. 14/308,462 entitled “Visual Axis Optimization for Enhanced Readability and Comprehension” filed on Jun. 18, 2014; contents of both applications are incorporated herein by reference in their entirety.

### BACKGROUND OF THE INVENTION

The ability to read is our greatest tool for education and transmission of ideas and the continuance of human evolution. Readability and comprehension of printed text or images are pivotal for teaching and communication. Historically, the text or images on a printed page are horizontally aligned to allow reading from left to right, right to left, or from top to bottom, since The Gutenbert Bible was printed in the mid-15th century. More more than 500 years, we failed to recognize that as we turn pages in a book, we also turn our face towards a right page or the left page resulting in an inevitable change in the axis of our eyes with the axis of the printed text or image that results in a subconscious stress that distracts the reader from the text or the image read. One would readily appreciate this stress and mental confusion if one were to read a book upside down. Our mind is trained from childhood to read along a linear axis, which is altered when we turn our face to read the left or the right page. This happens because as we turn our face, the axis of the eye shifts while the printed matter axis remains stationary. This misalignment produces stress, which is substantially higher in patients who have compromised mental abilities such as dyslexia, attention deficit hyperactivity disorder, and visuall discrimation issues. While most of the differences in the aptitude of the people in reading are attributed to their training and intellect, one cause that has never been fully recognized is the stress produced by reading a text or image with an axis that conflicts with the axis of the eye, an aspect that medical science is yet to identify. Reducing or eliminating this stress is pivotal to improving the readability of education material, more particularly helping subjects who have a lower threshold for this type of stress.

There is no known prior art to reduce the stress resulting from reading a text or image that has a different axis than the axis of the reading eyes. The instant invention resolves this inadequacy of the art by printing pages at an angle and as mirror images in their angle of printing keeping an acute angle on the left page and a reflex angle on the right pages.

### BRIEF SUMMARY OF THE INVENTION

Modern book construction follows a printing design developed some 500 years ago. A book comprises a plurality of leaves bound at the spine to create left and right pages, which are read by turning the face as we open the book in front of our face and hold it in our hands. Turning the face involves pivoting the face as we look down or up to read the book.

FIGS. 1a and 1b show the eye axis vis-à-vis the axis of text or image on the left and the right page demonstrating the discordance of the two axes.

FIG. 2. shows a method of calculating the horizontal axis of the eye as the face turns towards the left to read the left page and turns towards right to read the right page.

Dyslexia is a learning disability that manifests itself as a difficulty with word decoding and reading fluency. Comprehension may be affected because of challenges with decoding but is not a primary feature of dyslexia. It is separate and distinct from reading difficulties resulting from other causes, such as a non-neurological deficiency with vision or hearing, or from poor or inadequate reading instruction. It is estimated that dyslexia affect between 5-17% of the population. Dyslexia has been proposed to have three cognitive subtypes (auditory, visual and attentional), although individual cases of dyslexia are better explained by the underlying neuropsychological deficits and co-occurring learning disabilities (e.g. attention-deficit/hyperactivity disorder, math disability, etc.). Although not an intellectual disability, it is considered both a learning disability and a reading disability. Nerve problems can cause damage to the control of eye muscles which can also cause diplopia.

Attention-deficit/hyperactivity disorder (ADHD) is a brain disorder marked by an ongoing pattern of inattention and hyperactivity-impulsivity that interferes with functioning or development. Lack of attention in ADHD patients is clearly demonstrated in their reading abilities exacerbated by differences in the axes of the eye and the imprint.

Impaired visual processing issues are complex and include differentiating between two similar letters or shapes, characters, symbols, words, images, sequence, movement, etc.

Dyslexia, ADHD, and impaired visual processing issues patients, as well as other temporary or permanent conditions of the brain that affect ability to concentrate face higher stress when reading, further enhanced by the discordance in the axis of the eye and the axis of the text or image. The prior art is silent on any suggestions to bring the axis of text or image closer to the axis of the eyes when reading the left of the right page. There is, therefore, need to invent a method to improve the readability of imprint, more particularly in patients who have dyslexia or attention deficit hyperactivity disorder.

### BRIEF DESCRIPTION OF THE SEVERAL VIEWS OF THE DRAWINGS

FIG. 1A shows the eye axis with a traditional text or image on the left and right pages.

FIG. 1B shows the eye axis with angled text or image on the left and right pages as a mirror image in orientation.

FIG. 2 shows a method for determining an appropriate angle of printing.

### DETAILED DESCRIPTION OF THE INVENTION

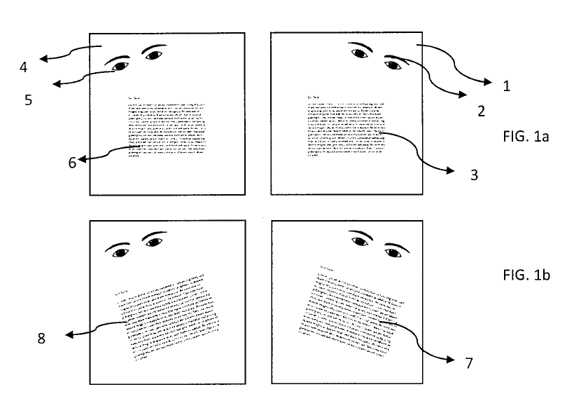

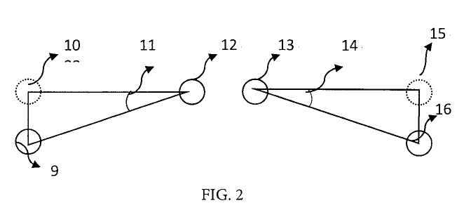

FIG. 1A shows a right page (1), eyes (2) reading the text or image (3) printed in a traditional manner, a left page (4) eyes (5) reading a text or image (6) printed in a traditional manner.

FIG. 1B shows the text or image printed at an angle to bring the axis of eyes (5 and 2) and the axis of text or image on the right page (8) and the left page (7) to better match the axes of the text or image and the eyes.

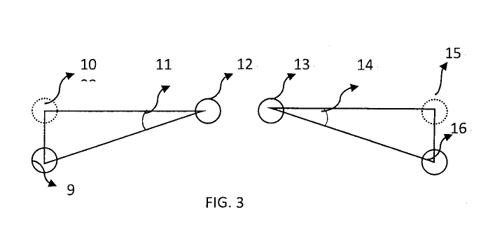

FIG. 2 shows a method for the calculations of an optimal angle of printing. The method involves recording linear focus points of the two eyes when the face is turned to read the left page or the right page. The focus points 13 and 15 shift to 13 and 16 on the right page and the focus points 10 and 12 shift to 12 and 9 change when the reader turns face to read the left page and angles of change in the axes are given by 11 and 14, which should be very close. The focus points 13, 15, 12, 10, 9 and 16 are recorded by a variety of mechanical and electronic means. For a mechanical device, one can dispose a narrow beam flashlight over the temples of the reader to focus light on a paper held at a normal reading distance. Turning face to the left and the right shows a change in the position of the light beam focussed on the paper providing the focus points to allow calculation of the angle of the shift. Using an electronic means, a device can readily track the movement of eyes observing a surface when the face is turned to read the left or the right page.

The change in the angle of the axis, negative and positive as seen on the right and the left pages are kept equal despite any variability in how different individuals turn their face because an exact alignment is not required for the invention to serve its purpose. The angles are averaged to provide a single angle most suitable for printing. It would not be practical to create a variety of angles in the printing of books to match the needs of target readers. To understand the range of variability in the angle of the axis of the eyes on the left and the right page, a study was conducted wherein 24 subjects ranging from 10 years to 62 years of age participated in the calculation of the acute and the reflex angles for the right and the left page as shown in FIG. 2. There was no significant difference in the angle for the left page and the right page. The range of angle recorded ranged from 5 to 20 degrees. The study participants were then asked to read a text printed at a 0, 5, 10 and 30-degree angle and reported better readability at all angled printing compared to 0-degree printed matter. On an average, a 10-degree angle provided best results. It is therefore concluded that if there is a change in the angle, albeit as small as 5 degrees and as large as 30 degrees, it will provide the functionality of the instant invention. The choice of angle will thus depend on the esthetics and physical limitations of the size of a book. Books have margins, and an angled printing of the text or image can bleed into the margin of the book, limiting the maximum angle of which a text or image can be printed. Further, there are anatomical limits to the maximum angle that can be practiced. As the face is turned, its movement is blocked by the neck and most people will find it difficult to turn their face beyond 30 to 35 degrees. For a most useful purpose, a text or image at an angle of 5-10 degrees, regardless of the nature of the book, irrespective of the age of the reader, would provide the most optimal utility of the invention.

The human mind is highly adaptive and capable of handling recognition of text or images, and it is for this reason, little attention is paid to the possibility of improving readability and comprehension in healthy subjects, and any abnormalities are attributed to mental abilities and capabilities. The instant invention recognizes that healthy subjects can also benefit from the instant invention. In situations where the reader is mentally tired, such as when preparing for exams, the instant invention can show a significant improvement in readability and comprehension by lowering the stress on the eyes. The instant invention, therefore, stands to contribute significantly to the productivity and efficiency of the reader. One aspect of the stress in reading can result in an aversion to reading, a phenomenon widely observed at all ages. Removing the stress in reading can reduce the aversion and thus increase literacy and wider use of books. More particularly, this may help children starting to read when they have not yet been accustomed to accommodating this stress in reading.

While the instant invention can significantly modify readability and comprehension by healthy subjects, the impact is understandably much higher in patients suffering from dyslexia, ADHD, and visual processing issues—all of whom have a lower threshold to handle mental stress.

The instant invention further promises to alleviate many symptoms such as headaches and other physiologic reactions as reported by many while reading.

Several essential elements of the instant invention must be thoroughly described to make the invention enabling. First, the invention describes an application to a bound volume wherein the left and the right pages are clearly differentiated. A single loose leaf of paper will not benefit from the instant invention as one can readily rotate the leaf to bring it within the limits of the axis of the eye without the need to turn the face. The invention will work equally well for all types of the direction of reading, from left to right, from right to left, and from top to bottom.

Modern printers print horizontally whether creating a text or image; to print at an angle, the word processors allow this function by converting text to an image, rotating the image and then printing it; alternately as provided by US Patent Application 2011/0286034 of Hirano, a software instruction to printer can print at an angle while the matter in a word processor screen is not angled. However, none of this art is prior art to the instant invention, nor is there any issue of inherency for several reasons. First, a mere ability to print at an angle does not teach the unexpected utility of the instant invention; second, the instant invention requires that it be limited to a bound printed book, that it have a mirror-image angles on the right and the left page, and that the angle of printing must confine itself to within a narrow range.

The instant invention as disclosed in its entirety enables practicing the invention without any undue trial. Printing at an angle between 5 to 30 degrees will be sufficient to achieve the utility of the invention; the size of margin can determine the exact angle in a book and the size of a bound book.

What is claimed is:

1. A book comprising:
a plurality of bound leaves having a left page and a right page;
a text or an image printed at an angle as mirror images on the left and the right pages in angular orientation.

2. The book of claim 1, wherein the left page is printed at an acute angle and the right page is printed at a reflex angle.

2. The book of claim 1, wherein the angle ranges between 5 and 30 degrees.

3. The book of claim 1, wherein the angle ranges between 5 and 10 degrees.

4. The book of claim 1, wherein the left and the right pages are read from right to left, from left to right or from top to bottom.

5. The book of claim 1, wherein the book is used by those in need of enhancing readability and comprehension of printed text and image.
